(19) United States
(12) Patent Application Publication
(10) Pub. No.: US 2006/0063073 A1
(43) Pub. Date: Mar. 23, 2006

(54) Electrode and battery

(76) Inventors: Atsumichi Kawashima, Kanagawa (JP); Takuya Endo, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/542,335

(22) PCT Filed: Jan. 21, 2004
(86) PCT No.: PCT/JP04/00486

§ 371 Date: Jul. 13, 2005

(30) Foreign Application Priority Data
Jan. 23, 2003 (JP) 2003-14657

(51) Int. Cl. H01M 2/16; H01M 10/40

(52) U.S. Cl. 429/246; 429/137; 429/342; 429/326

(57) ABSTRACT

An electrode and a battery coverable of improving cycle characteristics by forming an effective coat are provided. A cathode (21) and an anode (22) are wound with a separator (23) impregnated with an electrolytic solution inbetween. On the surface of the cathode (21) or the anode (22), a coat containing a compound, which has a smaller surface tension than of the electrolytic solution and is insoluble into the electrolytic solution, specifically, a coat containing siloxane such as poly (dimethyl siloxane), poly (methyl hydro siloxane), and poly (methyl phenyl siloxane), or perfluoro polyether such as poly (hexafluoro propylene oxide), or perfluoro alkane such as perfluoro pentadecane is provided. Thereby, without using a great deal of the compound for forming the coat, the coat effective to inhibit decomposition reaction of the electrolytic solution is formed.

### TECHNICAL FIELD

The present invention relates to a battery including a cathode, an anode, and an electrolytic solution, particularly using lithium (Li) and the like as electrode reacting species, and an electrode used for it.

### BACKGROUND ART

In recent years, many portable electronic devices such as a combination camera (video tape recorder), a digital still camera, a mobile phone, a personal digital assistance, and a laptop computer have been introduced, and downsizing and weight saving of these portable electronic devices have been made. Along with these situations, researches and developments to improve an energy density of a battery, particularly a secondary battery as a portable power source for these electronic devices have been actively promoted. Specially, a lithium ion secondary battery, using a carbon material as an anode active material and using a mixture of ester carbonate for an electrolyte is widely in practical use, since such a lithium ion secondary battery can provide a larger energy density compared to a lead battery, a nickel-cadmium battery, and a nickel-hydrogen battery, which are traditional aqueous solution-type electrolytic solution secondary batteries. According to this lithium ion secondary battery, it is expected that even after about 500 cycles of charge and discharge are repeated, about 60% of a discharge capacity is maintained. However, actually, the electrolytic solution is gradually reacted with the electrode active material and decomposed. Therefore, the discharge capacity becomes about 60% at about the 300th cycle, and it has been difficult to realize maintaining about 60% of a discharge capacity after repetition of about 500 cycles of charge and discharge. Therefore, it is widely implemented that various additives are added to an electrolytic solution to form a coat on the surface of an electrode (for example, refer to Japanese Unexamined Patent Application Publication No. 2001-307736).

However, when a traditional additive is used, it is not possible to form a sufficient coat unless a certain amount of the additive is added. Therefore, even though targeted characteristics can be improved, there have been problems such as that other characteristics are lowered, and that the manufacturing cost is increased.

### DISCLOSURE OF THE INVENTION

In view of the foregoing problems, it is an object of the invention to provide an electrode and a battery coverable of improving battery characteristics by forming an effective coat.

An electrode according to the invention is an electrode, in which on a surface, a coat containing at least one compound from the group consisting of siloxane, perfluoro polyether, perfluoro alkane, and derivatives thereof is provided.

A first battery according to the invention is a battery including a cathode, an anode, and an electrolytic solution, in which on at least one surface of the cathode and the anode, a coat containing at least one compound from the group consisting of siloxane, perfluoro polyether, perfluoro alkane, and derivatives thereof is provided.

A second battery according to the invention is a battery including a cathode, an anode, and an electrolytic solution, in which on at least one surface of the cathode and the anode, a coat containing a compound, which has a smaller surface tension than of the electrolytic solution and is insoluble into the electrolytic solution is provided.

In the electrode, the first battery, and the second battery according to the invention, the effective coat can be formed without using a great deal of the compound for forming the coat.

### BRIEF DESCRIPTION OF THE DRAWINGS

FIG. 1 is a cross section showing a construction of a secondary battery according to an embodiment of the invention;

FIG. 2 is a characteristics diagram showing cycle characteristics of secondary batteries according to Examples 1-1 to 1-3 of the invention; and

FIG. 3 is a characteristics diagram showing cycle characteristics of secondary batteries according to Examples 2-1 to 2-4 of the invention.

### BEST MODE FOR CARRYING OUT THE INVENTION

An embodiment of the invention will be hereinafter described in detail with reference to the drawings.

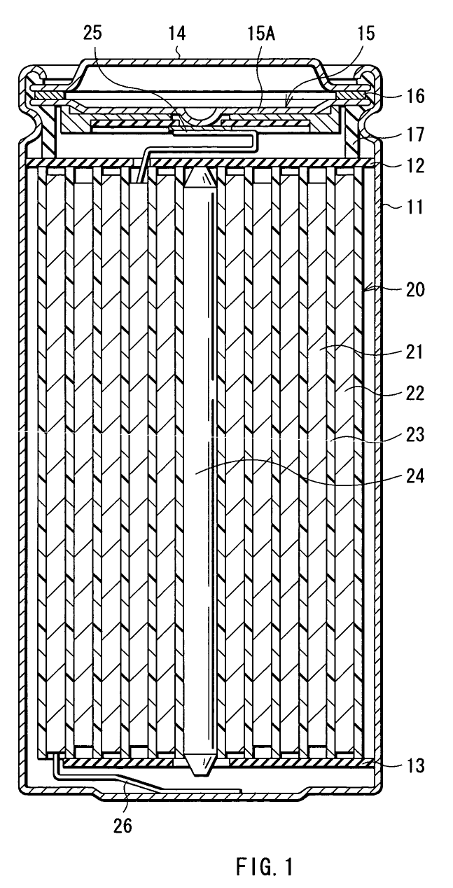

FIG. 1 shows a cross section structure of a secondary battery according to an embodiment of the invention. This secondary battery is a so-called cylindrical battery, and has a winding electrode body 20, in which a stripe-shaped cathode 21 and a stripe-shaped anode 22 are wound with a separator 23 inbetween inside a battery can 11 in the shape of an approximately hollow cylinder. The battery can 11 is made of, for example, iron (Fe) plated by nickel (Ni). One end of the battery can 11 is closed, and the other end of the battery can 11 is opened. Inside the battery can 11, an electrolytic solution, the liquid electrolyte is injected and impregnated into the separator 23. Further, a pair of insulating plates 12 and 13 is respectively arranged perpendicular to the winding periphery so that the winding electrode body 20 is sandwiched between the pair of insulating plates 12 and 13.

At the open end of the battery can 11, a battery cover 14, and a safety valve mechanism 15 and a Positive Temperature Coefficient device (PTC device) 16 provided inside the battery cover 14 are mounted by being caulked through a gasket 17. Inside of the battery can 11 is closed. The battery cover 14 is, for example, made of a material similar to that of the battery can 11. The safety valve mechanism 15 is electrically connected to the battery cover 14 through the PTC device 16. When an inner pressure of the battery becomes a certain level or more by inner short circuit or heating from outside, a disk plate 15A flips to cut the electrical connection between the battery cover 14 and the winding electrode body 20. When a temperature is raised, the PTC device 16 limits a current by increasing its resistance value to prevent abnormal heat generation by a large current. The PTC device 16 is made of, for example, barium titanate semiconductor ceramics. The gasket 17 is made of, for example, an insulating material and its surface is coated with asphalt.

The winding electrode body 20 is wound around, for example, a center pin 24. A cathode lead 25 made of aluminum (Al) or the like is connected to the cathode 21 of the winding electrode body 20, and an anode lead 26 made of nickel or the like is connected to the anode 22. The cathode lead 25 is electrically connected to the battery cover 14 by being welded to the safety valve mechanism 15. The anode lead 26 is welded and electrically connected to the battery can 11.

Though not shown, the cathode 21 has, for example, a structure, in which a cathode mixture layer is provided on one face or both faces of a cathode current collector having a pair of opposed faces. The cathode current collector is made of, for example, a metal foil such as an aluminum foil, a nickel foil, and a stainless foil. The cathode mixture layer contains, for example, one or more of cathode materials capable of inserting and extracting lithium, the light metal, as a cathode active material. The cathode mixture layer may also contain, if necessary, a conductive agent such as a carbon material and a binder such as polyvinylidene fluoride.

As a cathode material capable of inserting and extracting lithium, for example, a lithium-containing compound such as a lithium oxide, a lithium sulfide, and an interlayer compound containing lithium is suitable. A mixture of two or more thereof may be used. In particular, in order to increase an energy density, a lithium complex oxide expressed by a general formula of LiₓMO₂ or an interlayer compound containing lithium is preferable. M preferably contains one or more transition metals. Specifically, M preferably contains at least one from the group consisting of cobalt (Co), nickel, manganese (Mn), iron, aluminum, vanadium (V), and titanium (Ti). x varies according to charge and discharge states of the battery, and is generally in the range of 0.05≦x≦1.10. As a specific example of such a lithium complex oxide, lithium cobaltate (LiCoO₂), lithium nickelate (LiNiO₂), manganese spinel (LiMn₂O₄) or the like can be cited. In addition, a phosphoric acid compound such as lithium ferrous phosphate (LiFePO₄) having an olivine crystal structure is preferable since a high energy density can be thereby obtained.

As a cathode material capable of inserting and extracting lithium, other metal compound or a high molecular weight material can be also cited. As other metal compound, for example, an oxide such as titanium oxide, vanadium oxide, manganese dioxide, or a disulfide such as titanium sulfide and molybdenum sulfide can be cited. As a high molecular weight material, for example, a conductive macromolecule such as polyaniline and polythiophene can be cited.

Though not shown, as the cathode 21 does, the anode 22 has, for example, a structure, in which an anode mixture layer is provided on one face or both faces of an anode current collector having a pair of opposed faces. The anode current collector is made of, for example, a metal foil such as a copper foil, a nickel foil, and a stainless foil.

The anode mixture layer contains, for example, one or more of anode materials capable of inserting and extracting lithium as an anode active material. The anode mixture layer may also contain, if necessary, a binder similar to of the cathode 21. As an anode material capable of inserting and extracting lithium, a carbon material, a metal oxide, a high molecular weight material or the like can be cited. As a carbon material, non-graphitizable carbon, artificial graphite, cokes, graphites, glassy carbons, an organic high molecular weight compound fired body, carbon fiber, activated carbon, carbon blacks or the like can be cited. Of the foregoing, the cokes include pitch coke, needle coke, petroleum coke and the like. The organic high molecular weight compound fired body means a carbonized body obtained by firing a high molecular weight material such as phenols and furans at an appropriate temperatures. Further, as a metal oxide, iron oxide, ruthenium oxide, molybdenum oxide, tin oxide or the like can be cited. As a high molecular weight material, polyacetylene, polypyrrole or the like can be cited.

As an anode material capable of inserting and extracting lithium, simple substances, alloys, compounds of metal elements or metalloid elements capable of forming an alloy with lithium can be also cited. The alloys include an alloy composed of one or more metal elements and one or more metalloid elements, in addition to an alloy composed of two or more metal elements. Examples of the structure thereof include a solid solution, a eutectic crystal (eutectic mixture), an intermetallic compound, and a structure, in which two or more thereof coexist.

As a metal element or a metalloid element capable of forming an alloy with lithium, for example, magnesium (Mg), boron (B), arsenic (As), aluminum, gallium (Ga), indium (In), silicon (Si), germanium (Ge), tin (Sn), lead (Pb), antimony (Sb), bismuth (Bi), cadmium (Cd), silver (Ag), zinc (Zn), hafnium (Hf), zirconium (Zr), yttrium (Y), palladium (Pd), and platinum (Pt) can be cited. As an alloy or a compound thereof, for example, an alloy or a compound expressed by a chemical formula MaₛMbₜLiᵤ or a chemical formula MaₚMc_{q}Mdᵣ can be cited. In these chemical formulas, Ma represents at least one of metal elements and metalloid elements capable of forming an alloy with lithium. Mb represents at least one of metal elements and metalloid elements other than lithium and Ma. Mc represents at least one of nonmetallic elements. Md represents at least one of metal elements and metalloid elements other than Ma. Values of s, t, u, p, q, and r are in the range of s>0, t≧0, u≧0, p>0, q>0, and r≧0, respectively.

Specially, a simple substance, an alloy, or a compound of a metal element or a metalloid element of Group 4B in the short period periodic table is preferable. Silicon or tin, or an alloy or a compound thereof is particularly preferable. These simple substances, alloys, and compounds may be crystalline or amorphous.

Specific examples of such an alloy or such a compound include LiAl, AlSb, CuMgSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w≦2), SnSiO₃, LiSiO, and LiSnO.

The separator 23 separates the cathode 21 from the anode 22, prevents current short circuit due to contact of the both electrodes, and lets through lithium ions. The separator 23 is made of, for example, a porous film of a synthetic resin such as polytetrafluoro ethylene, polypropylene, and polyethylene, or a porous film of ceramics. The separator 23 may have a structure, in which two or more of these porous films are laminated.

An electrolytic solution impregnated in the separator 23 contains, for example, a solvent and a lithium salt, the electrolyte salt dissolved in the solvent. As a solvent, ester carbonate such as ethylene carbonate expressed in Chemical formula 1, propylene carbonate expressed in Chemical formula 2, dimethyl carbonate, diethyl carbonate, ethyl methyl carbonate, butylene carbonate expressed in Chemical formula 3, fluoro ethylene carbonate expressed in Chemical formula 4, and trifluoro propylene carbonate expressed in Chemical formula 5; or chain carboxylic ester such as methyl formate, ethyl formate, methyl acetate, ethyl acetate, methyl propionate, ethyl propionate, methyl butyrate, ethyl butyrate, methyl isobutyrate, and ethyl isobutyrate; or cyclic carboxylate ester such as γ-butyrolactone expressed in Chemical formula 6 and γ-valerolactone expressed in Chemical formula 7 can be used. Further, cyclic ether such as tetrahydrofuran and 1,3-dioxane can be used, since such cyclic ether has a higher viscosity than of chain carboxylic ester. Further, an amide compound such as N,N′-dimethyl formamide, N-methylpyrrolidone expressed in Chemical formula 8, and N-methyl oxazolidinone expressed in Chemical formula 9; or a sulfur compound such as sulfolane expressed in Chemical formula 10; or an ambient temperature molten salt such as tetrafluoro boric acid 1-ethyl-3-methyl imidazolium expressed in Chemical formula 11 can be used. In particular, as a main solvent, ester carbonate is preferably used. Ester carbonate is stable for oxidation and reduction, and a high voltage can be obtained. Further, carboxylate ester is preferable. Since carboxylate ester has the low melting point and the low viscosity, low temperature characteristics can be improved. In addition, carboxylate ester has high electric conductivity, and load characteristics can be improved. However, since carboxylate ester has a low reduction-resistant characteristics, carboxylate ester may be decomposed in the anode 22 to lower cycle characteristics. Therefore, it is preferable to mix carboxylate ester with ester carbonate.

As a lithium salt, for example, hexafluoro lithium phosphate (LiPF₆), tetrafluoro lithium borate (LiBF₄), lithium perchlorate (LiClO₄), hexafluoro lithium arsenate (LiAsF₆), trifluoro metane lithium sulfonate (CF₃SO₃Li), bis [trifluoro metane sulfonyl] imide lithium ((CF₃SO₂)₂NLi), tris (trifluoro metane sulfonyl) methyl lithium ((CF₃SO₂)₃CLi), bis [pentafluoro ethane sulfonyl] imide lithium ((C₂F₅SO₂)₂NLi) or the like can be cited. One kind thereof or a mixture of two or more kinds thereof may be used.

Instead of the electrolytic solution, a gelatinous electrolyte may be used. The gelatinous electrolyte is obtained by holding an electrolytic solution in a holding body. The holding body is made of, for example, a high molecular weight compound or an inorganic compound. As a high molecular weight compound, for example, an ether high molecular weight compound such as polyethylene oxide and a cross-linked body containing polyethylene oxide; an ester high molecular weight compound such as polymethacrylate or an acrylate high molecular weight compound; or a fluorine high molecular weight compound such as polyvinylidene fluoride and a copolymer of vinylidene fluoride and hexafluoro propylene can be cited. One kind thereof or a mixture of two or more kinds thereof is used. In particular, in view of redox stability, a fluorine high molecular weight compound is desirably used.

Further, in the secondary battery, on at least one surface of the cathode 21 and the anode 22, a coat containing a compound, which has a smaller surface tension than of the electrolytic solution and is insoluble into the electrolytic solution is provided. Such a compound spreads over while producing a thin film on the surface of the electrode, and therefore, the surface of the electrode can be widely coated even with a small amount of the compound. Therefore, in the secondary battery, without using a great deal of the compound for forming the coat, the coat effective to inhibit decomposition reaction of the electrolytic solution is formed. The coat may contain one kind or several kinds of the foregoing compound.

As a compound, which has a smaller surface tension than of the electrolytic solution and is insoluble into the electrolytic solution, for example, siloxane, perfluoro polyether, perfluoro alkane (saturated fluorocarbon), or a derivative thereof can be cited when the foregoing electrolytic solution is used. Specially, a compound, which is liquid at room temperatures is preferable. Further, a compound, which is solid by itself, but is liquid when mixed with other compound is preferable.

As siloxane, specifically, a compound having a structural part expressed by Chemical formula 13 can be cited.

As R1 and R2, for example, a hydrogen group (—H), an alkyl group (—CₘH₂ₘ₊₁), a hydrocarbon group having multiple bond such as a vinyl group (—CH═CH₂), an allyl group represented by a phenyl group (—C₆H₅), a fluorinated alkyl group, which is partly fluorinated or wholly fluorinated (—CₘF₂ₘ₊₁), an alcohol group (—CₘH₂ₘOH), a carboxylic acid group (—CₘH₂ₘCOOH), an alkoxy group (—OCₘH₂ₘ₊₁), a carboxylate ester group (—O—CO—CₘH₂ₘ₊₁), an acryloxy group (—CₘH₂ₘ—O—CO—CH═CH₂), or a methacryloxy group (—CₘH₂ₘ—O—CO—C(CH₃)═CH₂) can be cited. R1 and R2 are not necessarily one kind respectively, but may contain two kinds or more. R1 and R2 may be identical or different. m and n are given integer numbers, respectively. As such siloxane, specifically, poly (dimethyl siloxane), poly (methyl hydro siloxane), or poly (methyl phenyl siloxane) can be cited. These siloxanes are very inexpensive, and therefore are preferable economically. In particular, poly (dimethyl siloxane) and poly (methyl phenyl siloxane) are more preferable, since the material cost is about 1 yen per 10,000 pieces of batteries, and therefore, such material cost can be almost ignored in the manufacturing cost of the battery.

As perfluoro polyether, a compound having a structural part expressed by Chemical formula 14 can be cited.

As R3, for example, a fluorine group (—F), a perfluoro alkyl group (CₘF₂ₘ₊₁), a perfluoro alkyl ether group (—OCₘF₂ₘ₊₁), a perfluoro alcohol group (—CₘF₂ₘOH), a perfluoro carboxylic acid group (—CₘF₂ₘCOOH), or a perfluoro carboxylate ester group (—CₘF₂ₘCOOCₘH₂ₘ₊₁) can be cited. q is larger than p. In some cases, p is 0. R3 is not necessarily one kind, but may contain two or more kinds. m, p, and q are given integer numbers, respectively. As such perfluoro polyether, specifically, poly (tetrafluoro ethylene oxide) or poly (hexafluoro propylene oxide) can be cited.

As perfluoro alkane, the compound expressed by Chemical formula 15 can be cited. The structure thereof can be in the shape of a straight chain, or in the branched shape. In the formula, a represents a given integer number.

As such perfluoro alkane, a compound, in which a is 5 or more, and the boiling point is room temperature or more is preferable. For example, perfluoro pentadecane (Cl₅F₃₂) can be cited.

The content of the compound, which has a smaller surface tension than of the electrolytic solution and is insoluble into the electrolytic solution is preferably in the range from 100 ppm to 1000 ppm at a mass ratio to the electrolytic solution. Within this range, the thickness of the coat is not thickened more than necessary, and decomposition reaction of the electrolytic solution can be inhibited.

This secondary battery can be manufactured, for example, as follows.

First, for example, a cathode active material, a conductive agent, and a binder are mixed to prepare a cathode mixture. The cathode mixture is dispersed in a solvent such as N-methyl-pyrrolidone to obtain a cathode mixture coating liquid. Next, a cathode current collector is coated with the cathode mixture coating liquid, which is dried, and then the resultant is compression-molded to form a cathode mixture layer. In the result, the cathode 21 is formed.

Further, for example, an anode active material and a binder are mixed to prepare an anode mixture. The anode mixture is dispersed in a solvent such as N-methyl-pyrrolidone to obtain an anode mixture coating liquid. Next, an anode current collector is coated with the anode mixture coating liquid, which is dried, and then the resultant is compression-molded to form an anode mixture layer. In the result, the anode 22 is formed.

Subsequently, the cathode lead 25 is mounted to the cathode current collector by welding or the like, and the anode lead 26 is mounted to the anode current collector by welding or the like. After that, the cathode 21 and the anode 22 are wound with the separator 23 inbetween. An end of the cathode lead 25 is welded to the safety valve mechanism 15, and an end of the anode lead 26 is welded to the battery can 11. The wound cathode 21 and anode 22 are sandwiched between the pair of insulating plates 12 and 13, and housed inside the battery can 11. Next, the compound, which has a smaller surface tension than of the electrolytic solution and is insoluble into the electrolytic solution is dispersed in the electrolytic solution to fabricate a slurry. The slurry is injected inside the battery can 11. Thereby, the compound spreads over at least one surface of the cathode 21 and the anode 22, and a thin coat is formed. After that, at the open end of the battery can 11, the battery cover 14, the safety valve mechanism 15, and the PTC device 16 are fixed by being caulked through the gasket 17. Thereby, the secondary battery shown in FIG. 1 is completed.

In this secondary battery, when charged, for example, lithium ions are extracted from the cathode 21, and are inserted in the anode 22 through the electrolyte. When discharged, for example, lithium ions are extracted from the anode 22, and are inserted in the cathode 21 through the electrolyte. Then, decomposition reaction of the electrolytic solution is inhibited by the foregoing coat.

As above, in this embodiment, on at least one surface of the cathode 21 and the anode 22, the coat containing the compound, which has a smaller surface tension than of the electrolytic solution and is insoluble into the electrolytic solution, for example, at least one compound from the group consisting of siloxane, perfluoro polyether, perfluoro alkane and derivatives thereof is provided. Therefore, without using a great deal of the compound for forming the coat, decomposition reaction of the electrolytic solution can be effectively inhibited. Therefore, adverse affects by forming the coat and the manufacturing cost are held down, and at the same time battery characteristics such as cycle characteristics can be improved. Therefore, life to battery replacement can be lengthened. Consequently, under the same replacement frequency as of the traditional battery, the battery according to this embodiment can be used in a state of larger discharge capacity.

In particular, when the content of the compound, which has a smaller surface tension than of the electrolytic solution and insoluble in the electrolytic solution is in the range of 100 ppm to 1000 ppm at a mass ratio to the electrolytic solution, higher effects can be obtained.

Further, when the coat containing at least one compound from the group consisting of poly (dimethyl siloxane), poly (methyl hydro siloxane), and poly (methyl phenyl siloxane) is used, battery characteristics can be improved with smaller manufacturing cost.

In the foregoing embodiment, descriptions have been given with reference to the so-called lithium ion secondary battery using the anode material capable of inserting and extracting lithium as an anode active material. However, regarding other secondary battery, similar effects can be obtained when the foregoing coat is provided. That is, battery characteristics such as cycle characteristics can be improved.

As other secondary battery, for example, a so-called lithium secondary battery using a lithium metal as an anode active material can be cited. The lithium secondary battery has a construction similar to of the foregoing secondary battery and can be manufactured as in the foregoing secondary battery, except that the anode is made of the lithium metal.

Further, detailed descriptions will be given of specific examples of the invention with reference to FIG. 1.

### EXAMPLES 1-1 TO 1-3

First, 64 parts by mass of lithium cobaltate (LiCoO₂) as the cathode active material, 3 parts by mass of graphite as the conductive agent, and 3 parts by mass of polyvinylidene fluoride as the binder were uniformly mixed. After that, N-methylpyrrolidone was added to the mixture to obtain a cathode mixture coating liquid. Next, a cathode current collector made of an aluminum foil having a width of 56 mm, a length of 550 mm, and a thickness of 20 μm was uniformly coated with the obtained cathode mixture coating liquid, which was dried to form a cathode mixture layer having a thickness of 70 μm on the both faces of the cathode current collector. Thereby, the cathode 21 was fabricated. After that, the cathode lead 25 made of aluminum was mounted to an end of the cathode current collector.

Further, 94 parts by mass of graphite as the anode active material and 6 parts by mass of polyvinylidene fluoride as the binder were uniformly mixed. N-methylpyrrolidone was added to the mixture to obtain an anode mixture coating liquid. Next, an anode current collector made of a copper foil having a width of 58 mm, a length of 600 mm, and a thickness of 15 μm was uniformly coated with the obtained anode mixture coating liquid, which was dried to form an anode mixture layer having a thickness of 70 μm on the both faces of the anode current collector. Thereby, the anode 22 was fabricated. After that, the anode lead 26 made of nickel was mounted to an end of the anode current collector.

Next, the cathode 21 and the anode 22 were laminated with the separator 23 made of a micro porous polypropylene film having a thickness of 25 μm inbetween. After that, the laminated structure was wound by an winder to form the winding electrode body 20. The winding electrode body 20 was housed inside the battery can 11 made of stainless having a diameter of 18 mm and a length of 65 mm. A capacity of this battery is 200 mAh.

Next, in an electrolytic solution, in which ethylene carbonate, propylene carbonate, dimethyl carbonate, and hexafluoro lithium phosphate were mixed at a mass ratio of 20:10:10:50:20 having a surface tension of about 70 mN/m (dyn/cm) to 80 mN/m, poly (dimethyl siloxane) insoluble in the electrolytic solution having a kinetic viscosity of 100 mm²/S (cSt) and a surface tension of about 20 mN/m was dispersed to fabricate an slurry. 4.5 g of the slurry was injected inside the battery can 11. Then, contents of poly (dimethyl siloxane) to the electrolytic solution at a mass ratio were 100 ppm in Example 1-1, 500 ppm in Example 1-2, and 1000 ppm in Example 1-3.

After that, the battery cover 14 was mounted to the battery can 11 by being caulked through the gasket 17. Thereby, the cylindrical secondary battery shown in FIG. 1 was obtained for Examples 1-1 to 1-3.

Next, the obtained secondary batteries of Examples 1-1 to 1-3 were disassembled and observed. In the result, it was confirmed that a coat containing poly (dimethyl siloxane) was formed on the surface of the cathode 21 and the anode 22.

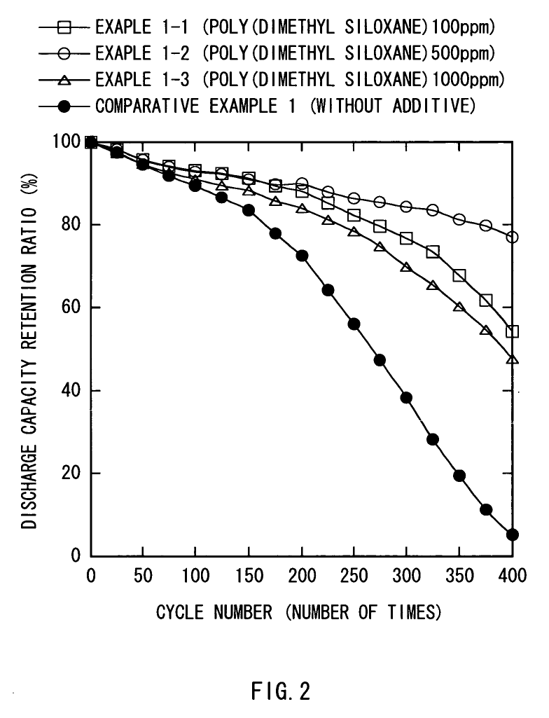

Further, regarding the obtained secondary batteries of Examples 1-1 to 1-3, a charge and discharge test was performed to examine cycle characteristics. The results thereof are shown in FIG. 2. In FIG. 2, the horizontal axis represents cycle numbers (numbers of times), and the vertical axis represents discharge capacity retention ratios (%). Charge was performed until the battery voltage reached 4.2 V at a constant current of 2 A, and then performed until the total charge time reached 4 hours at a constant voltage of 4.2 V. After 30 minutes recess of charge, discharge was performed until the battery voltage reached 3 V at a constant current of 2 A. The discharge capacity retention ratio was calculated as a rate (%) of the discharge capacity at each cycle to the discharge capacity at the first cycle.

As Comparative example 1 to Examples 1-1 to 1-3, a secondary battery was fabricated as in Examples 1-1 to 1-3, except that poly (dimethyl siloxane) was not used. Regarding the secondary battery of Comparative example 1, as in Examples 1-1 to 1-3, a charge and discharge test was performed to examine cycle characteristics. The result thereof is also As evidenced by FIG. 2, in Examples 1-1 to 1-3, in which the coat containing poly (dimethyl siloxane) was provided on the surface of the cathode 21 and the anode 22, compared to Comparative example 1 without the coat, decrease in the discharge capacity retention ratio when charge and discharge was repeated was small, and over 60% of the discharge capacity retention ratio was obtained even after 300 cycles of charge and discharge were repeated. Further, regarding decrease in the discharge capacity retention ratio when charge and discharge was repeated, the smallest level was obtained in Example 1-2. That is, it was found that when the coat containing siloxane was provided on the surface of the cathode 21 and the anode 22, the cycle characteristics could be improved even if the addition amount of siloxane is tiny. Further, it was found that when the mass ratio of siloxane to the electrolytic solution was in the range of 100 ppm to 1000 ppm, higher effects could be obtained.

### EXAMPLES 2-1 TO 2-4

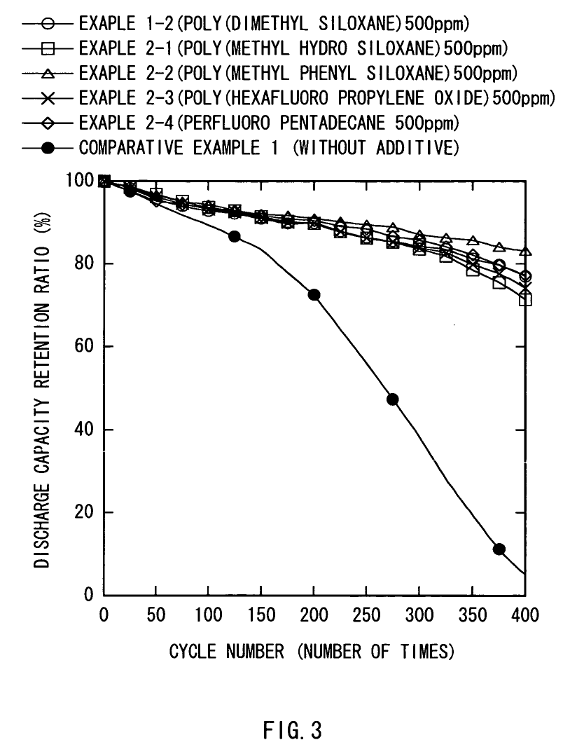

As Examples 2-1,2-2, 2-3, and 2-4, secondary batteries were fabricated as in Example 1-2, except that instead of poly (dimethyl siloxane), poly (methyl hydro siloxane), poly (methyl phenyl siloxane), poly (hexafluoro propylene oxide), and perfluoro pentadecane, which are insoluble into the electrolytic solution and have a kinetic viscosity of 100 mm²/S and a surface tension of about 20 mN/m were respectively used. The secondary batteries of Examples 2-1 to 2-4 were also disassembled and observed as in Example 1-2. In the result, it was confirmed that a coat containing poly (methyl hydro siloxane), poly (methyl phenyl siloxane), poly (hexafluoro propylene oxide), or perfluoro pentadecane was formed on the surface of the cathode 21 and the anode 22. Further, as in Example 1-2, a charge and discharge test was performed to examine cycle characteristics. The results thereof are shown in FIG. 3 along with the results of Example 1-2 and Comparative example 1.

As evidenced by FIG. 3, the decrease in the discharge capacity retention ratio after charge and discharge was repeated in Example 1-2 was not much different from that in Examples 2-1 to 2-4. That is, it was found that when the coat containing the compound, which has a smaller surface tension than of the electrolytic solution and is insoluble into the electrolytic solution was provided on the cathode 21 and the anode 22, cycle characteristics could be improved.

In the foregoing examples, descriptions have been given with reference to specific examples using poly siloxane, perfluoro polyether, and perfluoro alkane. However, when a coat of other poly siloxane, other perfluoro polyether, or other perfluoro alkane is provided, similar results can be obtained. Further, when a coat containing other compound, which has a smaller surface tension than of the electrolytic solution and is insoluble into the electrolytic solution is provided, similar results can be obtained. Further, in the foregoing examples, the case using the electrolytic solution has been described. However, when an electrolyte, in which an electrolytic solution is held in a holding body made of a high molecular weight compound or an inorganic compound is used, similar results can be obtained.

While the invention has been described with reference to the embodiment and examples, the invention is not limited to the foregoing embodiment and examples and various modifications may be made. For example, in the foregoing embodiment and examples, the compound, which has a smaller surface tension than of the electrolytic solution and is insoluble into the electrolytic solution is dispersed in the electrolytic solution to form the coat containing the compound in the battery. However, it is possible that after the coat is formed on the electrode, the battery is assembled.

Further, in the foregoing embodiment and the examples, the case using lithium as electrode reactive species has been described. However, the invention can be applied to the case using other alkali metal such as sodium (Na) and potassium (K), an alkali earth metal such as magnesium and calcium (Ca), other light metal such as aluminum, or an alloy of lithium or an alloy of the foregoing alkali metal, alkali earth metal, or other light metal, in which similar results can be obtained. In this case, the cathode active material, the anode active material, and the electrolyte salt are selected as appropriate according to the light metal. Other components can be constructed as in the foregoing embodiment.

Further, the invention can be applied not only to the cylindrical secondary battery having a winding structure, but to an oval or polygonal secondary battery having a winding structure, or to a secondary battery having a structure, in which the cathode and the anode are folded or laminated. In addition, the invention can be applied to a coin type, a button type, or a card type secondary battery as well. Further, the invention can be applied not only to the secondary battery, but also to other battery such as a primary battery. Further, the invention can be applied to an electric double layer capacitor using an electrolytic solution.

As described above, according to an electrode or a battery of the invention, the coat containing at least one compound from the group consisting of siloxane, perfluoro polyether, perfluoro alkane, and derivatives thereof, or a coat containing a compound, which has a smaller surface tension than of the electrolytic solution and is insoluble into the electrolytic solution is provided. Therefore, without using a great deal of the compound for forming the coat, decomposition reaction of the electrolytic solution can be effectively inhibited. Consequently, adverse affects by forming the coat and the manufacturing cost can be held down, and at the same time battery characteristics such as cycle characteristics can be improved.

In particular, according to the electrode or the battery of the invention, the content of the compound is in the range of 100 ppm to 1000 ppm at a mass ratio to the electrolytic solution. Therefore, higher effects can be obtained.

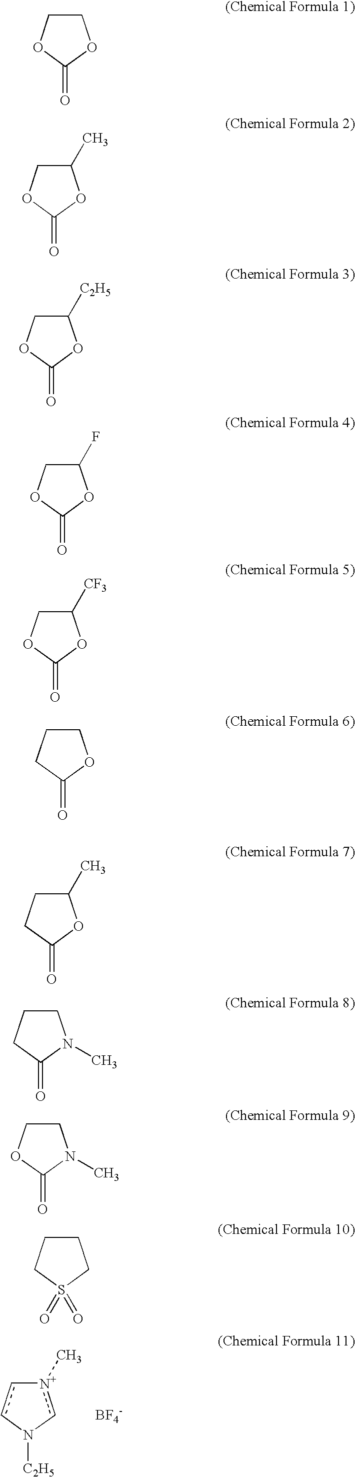

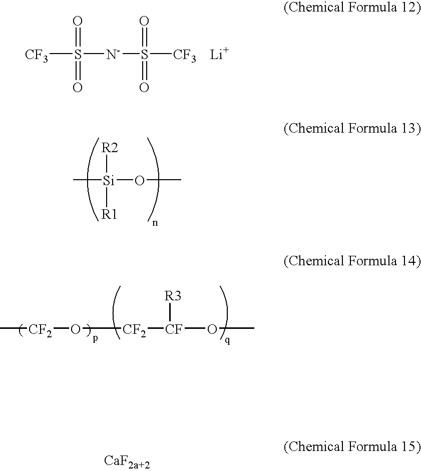

1. An electrode, wherein on a surface, a coat containing at least one compound from the group consisting of siloxane, perfluoro polyether, perfluoro alkane, and derivatives thereof is provided.

2. An electrode according to claim 1, wherein the coat contains at least one compound from the group consisting of poly (dimethyl siloxane), poly (methyl hydro siloxane), poly (methyl phenyl siloxane), poly (hexafluoro propylene oxide), and perfluoro pentadecane.

3. A battery comprising:
a cathode;
an anode; and
an electrolytic solution, wherein
on at least one surface of the cathode and the anode, a coat containing at least one compound from the group consisting of siloxane, perfluoro polyether, perfluoro alkane, and derivatives thereof is provided.

4. A battery according to claim 3, wherein the coat contains at least one compound from the group consisting of poly (dimethyl siloxane), poly (methyl hydro siloxane), poly (methyl phenyl siloxane), poly (hexafluoro propylene oxide), and perfluoro pentadecane.

5. A battery according to claim 3, wherein a content of the compound is in the range of 100 ppm to 1000 ppm at a mass ratio to the electrolytic solution.

6. A battery according to claim 3, wherein the electrolytic solution contains ester carbonate, or both ester carbonate and carboxylate ester.

7. A battery comprising:
a cathode;
an anode; and
an electrolytic solution, wherein
on at least one surface of the cathode and the anode, a coat containing a compound, which has a smaller surface tension than of the electrolytic solution and is insoluble into the electrolytic solution is provided.

8. A battery according to claim 7, wherein a content of the compound is in the range of 100 ppm to 1000 ppm at a mass ratio to the electrolytic solution.

9. A battery according to claim 7, wherein the electrolytic solution contains ester carbonate, or both ester carbonate and carboxylate ester.
